(19) United States
(12) Patent Application Publication
(10) Pub. No.: US 2016/0320092 A1
(43) Pub. Date: Nov. 3, 2016

(54) Series of Tanks That Forestall Mixing Fluids of Non-homogeneous Temperatures

(71) Applicant: Carl Snyder, High Point, NC (US)

(72) Inventor: Carl Snyder, High Point, NC (US)

(21) Appl. No.: 15/144,742

(22) Filed: May 2, 2016

Related U.S. Application Data
(60) Provisional application No. 62/179,198, filed on May 1, 2015.

(51) Int. Cl. F24H 1/18; F24H 1/00; H05B 1/02; E03B 11/02

(52) U.S. Cl. CPC F24H 1/185; E03B 11/02; F24H 1/0018; H05B 1/0244

(57) ABSTRACT

A new method and system of heat conservation, heat exchange, and incremental heat displacement facilitated by a series of tanks that forestall the mixing of fluids with non-homogeneous temperatures is described. The system employs specially crafted tanks containing a liquid. The heating of the liquid is regulated by a microprocessor, which monitors the independent temperature of the liquid within each of the tanks of the series of tanks, and only permits the activation of the heating coils to one tank at a time, with priority given to the tank closest to the output. The series of tanks are insulated, and are configured to maintain the approximate temperature determined by the owner or user. Each tank is equipped with an independent heater and temperature sensor. The tanks are prioritized to specifically heat those that need it the most.

This application is a non-provisional patent application of provisional patent application No. 62/179,198, filed on May 1, 2015, and priority is claimed thereto.

### FIELD OF THE PRESENT INVENTION

The present invention relates generally to systems and methods configured to exchange heat, and more specifically relates to a system of tanks configured to maximize the efficacy of fluidic heat exchange by means of incremental computer-regulated exchangers.

### BACKGROUND OF THE PRESENT INVENTION

Water heating is the second largest consumer of energy in the home, second only to air-conditioning & heating. In many regions, water heat represents 20-30% of total residential energy consumption. The problem with conventional water heaters is that they are centrally located and it takes up to two minutes for hot water to arrive at the faucet. All most individuals need is enough hot water to wash your hands or shave—normally less than a quart. In the process however, several gallons of water are wasted, and the energy used to heat it is lost in the water lines between the central water heater and the faucet.

Temperature-controlled water and other fluid tanks are used in a variety of applications including conventional water heaters. Normal operation involves extraction of fluid from one end of the tank (service end) at a design temperature, and simultaneous replenishment at the other end (source end) with the same fluid, but at a different temperature. As the fluid at the service and source ends of the tank immediately begin mixing when fluid is extracted from the tank, the average temperature in the tank begins to deviate from the design temperature upon use. The temperature control system works to bring all of the fluid back to the design temperature, but this temperature normalization takes time. If only a small percentage of fluid is exchanged over a short time period, the temperature change in the tank may not be a problem. However, if a substantial percentage of the fluid is exchanged over a short period, the average fluid temperature in the tank may fall out of specification.

This is usually the case with conventional heat exchangers employed in Point-of-Use (POU) systems, such as those configured to quickly heat water near a kitchen faucet, or in some lavatories. POU systems are often combined with large-capacity primary systems with the water source of the POU system tied to the hot water service end of the primary system. In the absence of continuous recirculation, water held in the lines between the primary and POU system cools to ambient temperature over time. Therefore, in the case of the conventional mini-tank POU system, cold and hot water immediately begin to mix when the faucet is turned on. Service water temperature begins to fall and high power levels (1,200 W plus) are used to compensate.

In the commercial sector, water heating accounts for about 10% of total energy consumption. Hot water consumption patterns in most commercial buildings are characterized as high- or low-use, with not too much in between. High-use consumers include lodging establishments, hospitals, and restaurants, while low-use consumers include small retail, office buildings, and schools. At one extreme are office, assembly, and retail establishments where hot water use is frequently less than 5 gallons per day, and individual draws are less than 1 gallon. On the other extreme are facilities with significant process loads such as food service, laundry, and health care facilities. These facilities may consume hundreds to thousands of gallons of hot water per day.

The POU water heater of the present invention is best suited for applications where there is only an occasional demand for hot water. In schools and commercial buildings that do not have high process loads for hot water, central water heaters typically waste more hot water than they deliver. This is caused by distribution losses in long piping runs between the water heater and point of use, whether or not there is a recirculating loop between them. If draws are sporadic, losses are greatest.

Thus, there is a need for a system and apparatus that facilitates effective heat exchange without the use of (comparatively) high power output (+1,200 W) that can regulate the average temperature of the circulated liquid in a controlled manner. Such a system preferably employs multiple, independent insulated heat exchangers, arranged in a series, and regulated via a microprocessor. As such, such a system provides distributed, compartmentalized liquid heat exchange system to maximize water, power, and time savings. Additionally, such a system, employing such low power, could be used on boats, RVs, and similar vehicles to provide users with efficient and safe hot water via DC power.

### SUMMARY OF THE PRESENT INVENTION

The present invention relates to a new method and system of heat conservation, heat exchange, and incremental heat displacement facilitated by a series of temperature-regulated tanks that forestall the mixing of fluids with non-homogeneous temperatures, yielding a more efficient, effective, and economical means of fluid temperature regulation.

The present invention is configured for use in water heaters of any size. In the case of conventional household water heaters (e.g. 70 gallon system) the conventional system can be replaced with a smaller and more efficient system of the present invention that delivers the same volume of hot water at the design temperature, but with less energy consumption. A separate application of the system of the present invention is the Point-Of-Use (POU) system, in which water is heated at or near delivery (i.e. faucet). Existing POU systems fall into two general categories tank-less systems, and mini-tank heaters.

For such uses, the system of the present invention employs a well-insulated, multi-tank system, and the majority of the contents are available at the design temperature. The source and the service ends of the tank are separated through a multi-tank system such that a thermal barrier exists between each tank. Each tank section has a separate heater and temperature monitor, being selectively controlled by a microprocessor. The tanks are prioritized to receive heating, with the service end having heating priority, and each successive tank in the system having a lower priority.

In the United States, the present invention is preferably powered by a 12V/40 W Class-II transformer that plugs into a conventional 120 v AC outlet. If 120 volt power exists near the installation, electrical hookup is just a matter of plugging in the transformer. If power does not exist near the installation, two wiring options exist; 1) plug the transformer into the nearest 120 VAC outlet and route the low-voltage wire (no conduit or junction box needed) to the water heater; or 2) daisy chain off of an existing power outlet nearby and install a 120 VAC outlet near the water heater. It should be understood that the use of the present invention is not restricted to US power standards, and may be configured for use in international power systems. The goal is to not require any special wiring to power the system of the present invention. It is envisioned that use of the present invention is designed to be powered via conventional power from a household plug.

The biggest factor in the service life of conventional water heaters is the accumulation of minerals such as calcium carbonate in the tank. Minerals dissolve in water stored in large tanks for long periods of time, and is exacerbated by direct exposure to heating elements that induce mineral separation from the water. These minerals deposit on tank walls and heating elements, causing reduced efficiency and heating element failure.

This problem can also persist with electric tank-less water heaters. One electric utility determined that electric tank-less water heaters have even worse problems with calcium residue because the small amount of water remaining in the unit causes minerals to boil out and deposit onto the heating elements.

Heating elements in the present invention never come into direct contact with water. Therefore, the issues with conventional water heaters, including mineral separation caused by direct exposure to heating elements, as well as heating element failure caused by exposure, are eliminated.

The risk of electric shock is always a factor when you combine water and electricity, and it's worse with higher voltage/power circuits. Since the present invention operates on low-power/voltage, the risk of electric shock is virtually eliminated.

### BRIEF DESCRIPTION OF THE DRAWINGS

The present invention will be better understood with reference to the appended drawing sheets, wherein:

FIG. 1 displays a schematic of the system of the present invention.

FIG. 2 exhibits a side view of the series of tanks of the present invention.

FIG. 3 shows a flow chart depicting the progressive flow of liquid throughout the system of the present invention.

### DETAILED DESCRIPTION OF THE PREFERRED EMBODIMENT

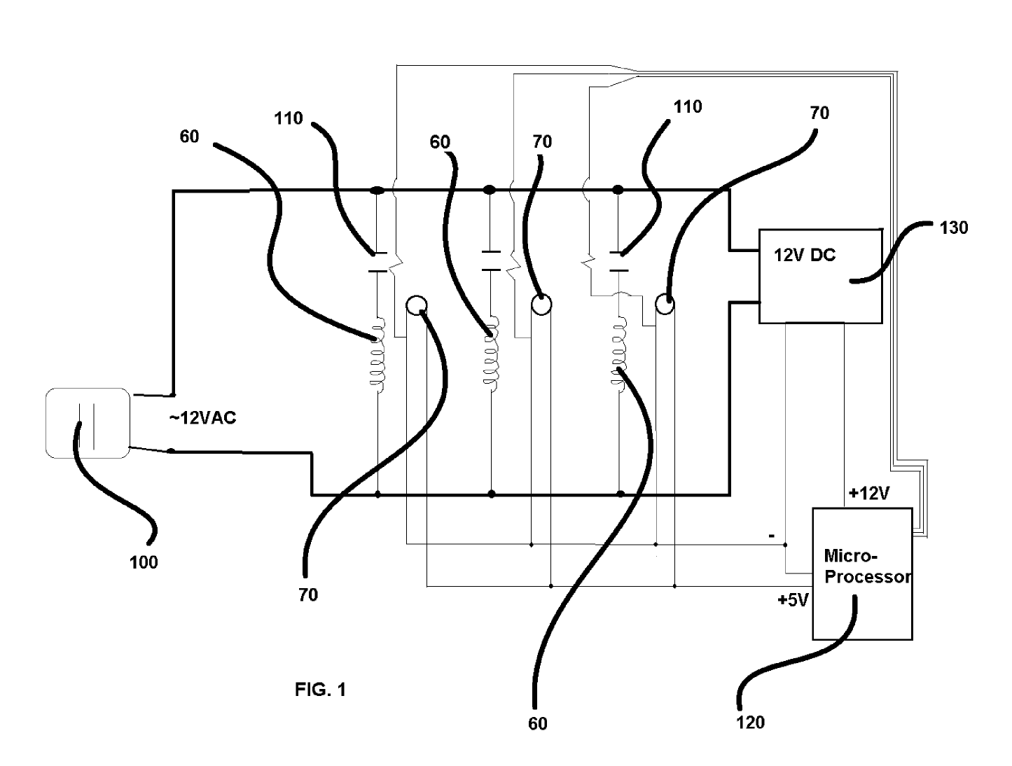

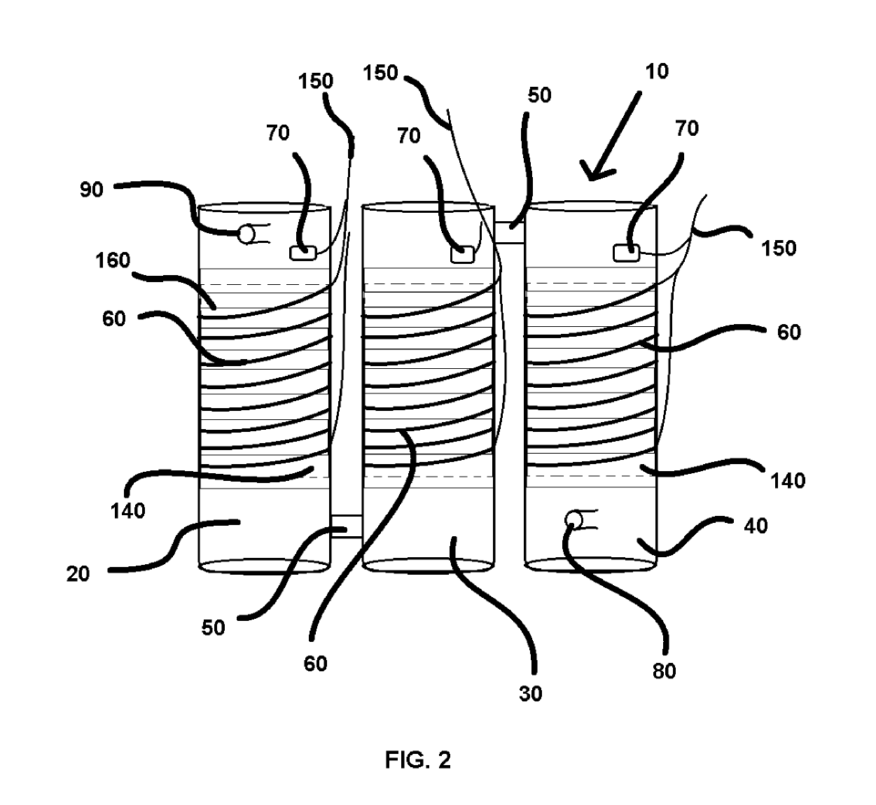

The present invention is a heat conservation and exchange system configured for the efficient regulation of the temperature of a liquid. The preferred embodiment of the present invention is equipped with a series of tanks (10) which preferably include a first tank (20), a second tank (30), and a third tank (40). It is envisioned that additional tanks may be employed in alternate embodiments of the present invention, for applications larger in scale. The series of tanks (10) are preferably connected via pipe fittings (50). Each of the tanks of the series of tanks (10) is independently equipped with a heating coil (60), a temperature sensor (70), an input (80) and an output (90), as shown in FIG. 2. It should be understood that the input (80) is connected to the water source. The heating coils (60) are in communication with a power source (100), which is preferably a 12 v AC supply. 12 v DC relays (110) are disposed in communication with the heating coils (60) as shown in FIG. 1. A Class II 40 watt transformer is preferably employed. Two wires (150) connect the heating coils (60) to the power source (100). Wires (150) also connect the temperature sensors (70) to the microprocessor (120) and power source (100). Wires (150) also connect heater relay coils to the microprocessor (120).

The system of the present invention is also equipped with a microprocessor (120) which is preferably connected to a DC power supply (130). The microprocessor (120) is in communication with each temperature sensor (70) disposed externally on each of the series of tanks (10). The microprocessor (120) is preferably programmed to regulate the temperature of each of the tanks of the series of tanks independently, activating the corresponding heating coil (60) to tanks having the greatest priority, the microprocessor (120) activating the heating coil (60) of the tank with a temperature that varies from the design temperature. When more than one tank of the series of tanks (10) requires heating, priority is given to the tank closest to the output (90). Insulation is preferably disposed between each tank to aid thermal retention, and maintain the independence of each tank of the series of tanks (10). Additionally, electrical insulator Nomex™ (140) or a similar electrical insulating material, is preferably disposed between the heating coils (60) and the tanks, as shown in FIG. 2. As such, the heating coils (60) are wrapped around the electrical insulator Nomex™ (140), which is wrapped around each of the series of tanks (10) independently for shortage prevention.

Using this novel design for the POU system, the issue of mixing fluids with disparate temperatures is eliminated for small volumes of water usage, as is typical for a lavatory sink, and the power required to maintain the desired water temperature is a fraction of that used in conventional POU systems. The energy required to maintain a useful amount of hot water, such as a half gallon, is low, and is dispensed at a consistent temperature, whereas competing systems get colder after the first second of use.

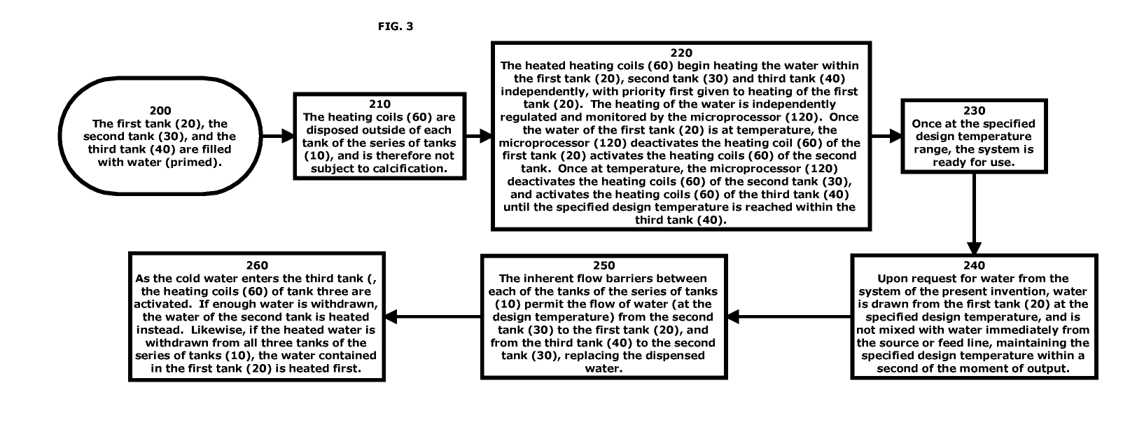

In addition, the novel POU system can be tied to the cold-water supply, and thus avoid heat losses in the line. In the case of a larger volumes of water being required, a three-way valve is installed at the source end of the POU system that temporarily ties the POU source to the hot-water feed from the primary water heater. FIG. 2 and FIG. 3 show ways of accomplishing thermal separation, but should not be interpreted as the only arrangement of the components of the system of the present invention.

The net effect of the present invention is that a small divided tank can be used to deliver a volume of liquid at the specified design temperature. This affords the opportunity of conserving energy and water or other fluid. The volume of liquid dispensed is immediately replenished via the successive tank which is still at the specified design temperature. This act is preferably regulated by the microprocessor (120).

The system of the present invention, as depicted in FIG. 3, preferably functions as follows:
1. The first tank (20), the second tank (30), and the third tank (40) are filled with water (primed). (200) The water is at the ambient temperature if connected to the cold water supply line, or alternatively connected to the hot water supply line for hot water priming.
2. The heating coils (60) are disposed outside of each tank of the series of tanks (10), and are therefore not subject to calcification. (210)
3. The heated heating coils (60) begin heating the water within the first tank (20), second tank (30) and third tank (40) independently, with priority first given to heating of the first tank (20). The heating of the water is independently regulated and monitored by the microprocessor (120). Once the water of the first tank (20) is at temperature, the microprocessor (120) deactivates the heating coil (60) of the first tank (20) activates the heating coils (60) of the second tank. Once at temperature, the microprocessor (120) deactivates the heating coils (60) of the second tank (30), and activates the heating coils (60) of the third tank (40) until the specified design temperature is reached within the third tank (40). (220)
4. Once at the specified design temperature range, the system is ready for use. (230)
5. Upon request for water from the system of the present invention, water is drawn from the first tank (20) at the specified design temperature, and is not mixed with water immediately from the source or feed line, maintaining the specified design temperature within a second of the moment of output. (240)
6. The inherent flow barriers between each of the tanks of the series of tanks (10) permit the flow of water (at the design temperature) from the second tank (30) to the first tank (20), and from the third tank (40) to the second tank (30), replacing the dispensed water. (250)
7. As the cold water enters the third tank (40), the heating coils (60) of tank three are activated. If enough water is withdrawn, the water of the second tank is heated instead. Likewise, if the heated water is withdrawn from all three tanks of the series of tanks (10), the water contained in the first tank (20) is heated first. (260)

It should be understood that the present invention is envisioned for use in conventional faucet locations, including but not limited to:
Residential Bathroom Sinks
Kitchen and Bar Sinks
Workshop and Utility Sinks
Office Lavatories
RVs, Campers, and Boats
Lab Sinks

In the preferred embodiment of the present invention, only three tanks are used, the first tank (20), the second tank (30), and the third tank (40), which are connected in a daisy-chain configuration such that water flows from the water source to the third tank (40) first, then to the second tank (30), and then to the first tank (20) before emerging at the output (90) for use. As such, the tanks are connected with pipes (50) in a way that tries to avoid water mixing. For instance, the third tank (40) has ambient temperature water entering via the input (80) at the bottom of the tank as seen in FIG. 2. The second tank (30) is connected to the third tank (40) at the opposite end from the input (80), at the top of the second tank (30) and top of the third tank (40), as shown in FIG. 2. The bottom of the second tank (30) is then connected to the bottom of the first tank (20), and the output (90) is disposed at the top of the first tank (20). A total of one gallon of hot water is preferably stored within the series of tanks (10) of the preferred embodiment of the present invention.

Alternate embodiments of the present invention include variations on the number of tanks employed in the series of tanks (10), variations on the type of insulation employed, as well as variations on the size of the tanks. It is envisioned that electrical tape (160) (or equivalent) is employed to cover the heating coils (60) over the electrical insulator Nomex (140) to hold the heating coils (60) and Nomex (140) in position on the tanks. It is envisioned that silicone may be used in lieu of the electrical tape (160) in other embodiments of the present invention. Additionally, in all embodiments of the present invention, the series of tanks (10) is preferably encased in a form of thermal insulation to aid heat retention.

In some alternate embodiments of the present invention, the power source (100) may be solely DC power. This can be helpful for the integration of the present invention for use on boats, RVs, or similar vehicles. In general, it is a goal of the present invention to be suitable for use anywhere, and therefore it is critical that no special wiring or circuits are required for installation and use. As the class II 40 watt transformer is used, very little power is provided to the heating coils (60), and the system does not present a fire hazard. The use of this transformer makes the system of the present invention exempt from certain wiring NEC rules, as current is limited. With such low wattage, current is only independently provided to one tank of the series of tanks (10) at a time.

At least one embodiment of the present invention is designed for use with freestanding or wall-mounted sinks. It is an in-wall installation and fits between studs in conventional 2×4 wall construction. Other embodiments of the present invention are designed for use in vanity or cabinet installations where the location inside the cabinet, under the sink, is most appropriate. All embodiments of the present invention are envisioned to operate on low-voltage output from a Class II transformer, and only draws a maximum of 40 watts. Other wattages may become available in low voltage systems similar to Class II. It is envisioned that a switch available to the user to set the specified design temperature for use. The switch preferably enables the target design temperature to be set to 110, 120, 125, or other values. The microprocessor (120) is configured to raise the temperature of the water within the highest priority tank first, and preferably overheats the water slightly, such that it may be allowed to cool slightly as power is subsequently diverted to the heating coil (60) of the next priority tank. Temperature ranges are preferably used in lieu of a specific target temperature.

The temperature of the tanks is preferably detected externally via the temperature sensors (70). As the tanks of the series of tanks (10) are preferably made of stainless steel, heat is well distributed to the entirety of the tank such that an external temperature reading is accurate. Therefore, the temperature sensors (70) need not be disposed in contact with the water within the series of tanks (10). In alternate embodiments of the present invention, the hot water line may be connected in addition to the cold water line, via a three-way valve. The series of tanks (10) of the present invention could then be primed with hot water upon initial use, or primed after a prolonged use (greater than approximately one gallon), making it easier to maintain the specified design temperature of the water.

The preferred embodiment of the present invention is ideally suited for low, to occasional-use fixtures such as a lavatory sink. In these scenarios, the present invention would normally be plumbed to the cold-water line. Hot-water draws are typically small (one or two quarts), and are separated in time such that cold water entering the system has sufficient time to heat between draws. Distribution losses are eliminated in this configuration. Installations where draws are sometimes higher in volume, such as the kitchen sink, it might be appropriate to plumb the system of the present invention to the hot water line. If all of the hot water is drawn from the system, one must only wait until hot water from the central heater arrives to carry on with the task at hand. In addition, hot water from the central tank acts to re-prime the series of tanks (10) of the system of the present invention.

Additionally, another alternate embodiment of the present invention envisions a single tank equipped with internal partitions, rather than and external series of tanks (10) as shown in the preferred embodiment. In such an embodiment, insulated barriers exist within the tank, and act to partition the tank into three separate segments. The remaining components and features of the present invention are akin to those of the preferred embodiment of the present invention.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A system for regulating the temperature of a liquid comprising:
a first tank;
a first heating coil, said first heating coil circumscribing said first tank;
a second tank;
a second heating coil, said second heating coil circumscribing said second tank;
a third tank;
a third heating coil, said third heating coil circumscribing said third tank;
a power source, said power source in communication with said first heating coil, said second heating coil, and said third heating coil;
wherein said first tank has a first input and a first output;
wherein said second tank has a second input and a second output;
wherein said third tank has a third input and a third output;
wherein said first input is in communication with said second output;
wherein said second input is in communication with said third output;
wherein said third input is plumbed to a water line;
a microprocessor;
a first temperature sensor, said first temperature sensor configured to detect the temperature of liquid within said first tank;
a second temperature sensor, said second temperature sensor configured to detect the temperature of liquid within said second tank;
a third temperature sensor, said third temperature sensor configured to detect the temperature of liquid within said third tank;
wherein said first temperature sensor, said second temperature sensor, and said third temperature sensor are configured to relay temperature data to said microprocessor;
wherein said microprocessor is in communication with said first heating coil, said second heating coil, and said third heating coil;
wherein said microprocessor is configured to regulate the temperature of said first tank, said second tank, and said third tank independently, activating said first heating coil, said second heating coil, and said third heating coil as demand requires to attain a specified design temperature of the liquid; and
wherein said microprocessor is configured to prioritize activation of said first heating coil before said second heating coil, and said second heating coil before said third heating coil.

2. The system of claim 1, wherein said first tank is equipped with a first tank top and a first tank bottom;
wherein said second tank is equipped with a second tank top and a second tank bottom;
wherein said third tank is equipped with a third tank top and a third tank bottom;
wherein said first tank bottom is connected to said second tank bottom via said first tank output and said second tank input;
wherein said second tank top is connected to said third tank top via said second tank output and said third tank input;
wherein said third tank output is disposed at said third tank bottom; and
wherein said first tank input is disposed at said first tank top.

3. The system of claim 1, wherein said first temperature sensor is disposed on an outside of said first tank;
wherein said second temperature sensor is disposed on an outside of said second tank;
wherein said third temperature sensor is disposed on an outside of said third tank; and
wherein said first temperature sensor, said second temperature sensor, and said third temperature sensor do no contact the liquid.

4. The system of claim 1, further comprising electrical insulation;
wherein said electrical insulation is disposed between said first heating coil and said first tank;
wherein said electrical insulation is disposed between said second heating coil and said second tank; and
wherein said electrical insulation is disposed between said third heating coil and said third tank.

5. The system of claim 4, wherein said electrical insulation is Nomex™.

6. The system of claim 1, wherein said first tank, said second tank, and said third tank are stainless steel cylinders.

7. The system of claim 1, wherein said microprocessor assigns priority of heating to said first tank when the temperature of the liquid within said first tank is below said specified design temperature;
wherein said microprocessor assigns priority of heating to said second tank when the temperature of the liquid within said first tank is at said specified design temperature; and
wherein said microprocessor assigns priority of heating to said third tank when the temperature of the liquid within said first tank and said second tank is at said specified design temperature.

8. The system of claim 2, wherein said first temperature sensor is disposed on an outside of said first tank;
wherein said second temperature sensor is disposed on an outside of said second tank;
wherein said third temperature sensor is disposed on an outside of said third tank; and
wherein said first temperature sensor, said second temperature sensor, and said third temperature sensor do not contact the liquid.

9. The system of claim 2, further comprising electrical insulation;
wherein said electrical insulation is disposed between said first heating coil and said first tank;
wherein said electrical insulation is disposed between said second heating coil and said second tank; and
wherein said electrical insulation is disposed between said third heating coil and said third tank.

10. The system of claim 2, wherein said first tank, said second tank, and said third tank are stainless steel cylinders.

11. The system of claim 2, wherein said microprocessor assigns priority of heating to said first tank when the temperature of the liquid within said first tank is below said specified design temperature;
wherein said microprocessor assigns priority of heating to said second tank when the temperature of the liquid within said first tank is at said specified design temperature; and
wherein said microprocessor assigns priority of heating to said third tank when the temperature of the liquid within said first tank and said second tank is at said specified design temperature.

12. The system of claim 3, wherein said first tank is equipped with a first tank top and a first tank bottom;
wherein said second tank is equipped with a second tank top and a second tank bottom;
wherein said third tank is equipped with a third tank top and a third tank bottom;
wherein said first tank bottom is connected to said second tank bottom via said first tank output and said second tank input;
wherein said second tank top is connected to said third tank top via said second tank output and said third tank input;
wherein said third tank output is disposed at said third tank bottom; and
wherein said first tank input is disposed at said first tank top.

13. The system of claim 1, wherein said power source has an output of 40 watts via a Class II 40 Watt transformer.

14. A method for warming a liquid to a specified design temperature comprising:
priming a first tank, a second tank, and a third tank by filling the first tank, second tank, and third tank with water;
wherein said first tank has a first input disposed at a first top, and a first output disposed at a first bottom;
wherein said second tank has a second input disposed at a second bottom, and a second output disposed at a second top;
wherein said third tank has a third input disposed at a third top, and a third output disposed at a third bottom;
arranging the first tank such that the first output is in communication with said second input;
arranging the second tank such that the second output is in communication with said third input;
wrapping the first tank with a first heating coil;
wrapping the second tank with a second heating coil;
wrapping the third tank with a third heating coil;
connecting the first heating coil, the second heating coil, and the third heating coil to a power source via wires;
connecting the first heating coil, the second heating coil, and the third heating coil to a microprocessor via wires;
attaching a first temperature sensor to the first tank;
attaching a second temperature sensor to the second tank;
attaching a third temperature sensor to the third tank;
connecting the first temperature sensor, the second temperature sensor, and the third temperature sensor to the microprocessor via wires;
connecting the first temperature sensor, the second temperature sensor, and the third temperature sensor to the power source via wires;
connecting the first input to a source line, permitting the flow of liquid into the first tank, then the second tank, then the third tank;
the first temperature sensor monitoring the temperature of the first tank;
the first temperature sensor relaying the temperature of the first tank to the microprocessor;
the microprocessor instructing the first heating coil to activate, heating the liquid within the first tank first;
the second temperature sensor monitoring the temperature of the second tank;
the second temperature sensor relaying the temperature of the second tank to the microprocessor;
the microprocessor instructing the second heating coil to activate, heating the liquid within the second tank after the liquid within the first tank reaches a specified design temperature;
the third temperature sensor monitoring the temperature of the third tank;
the third temperature sensor relaying the temperature of the third tank to the microprocessor;
the microprocessor instructing the third heating coil to activate after the liquid within the second tank reaches the specified design temperature; and
the microprocessor instructing the third heating coil to deactivate after the liquid within the third tank achieves the specified design temperature.
